(19) United States
(12) Patent Application Publication
(10) Pub. No.: US 2026/0221856 A1
(43) Pub. Date: Jul. 30, 2026

(54) SQUIRREL CAGE INDUCTION MACHINE ROTOR WITH ENLARGED CONNECTION REGION

(71) Applicant: Atieva, Inc., Newark, CA (US)

(72) Inventors: Sabrina Santos Samaniego, Fremont, CA (US); Mingda Liu, Sunnyvale, CA (US); Michael Abosch, San Carlos, CA (US); Shun-Cheng Hung, Taipei City (TW)

(21) Appl. No.: 19/041,247

(22) Filed: Jan. 30, 2025

(51) Int. Cl. H02K 17/16

(52) U.S. Cl. CPC H02K 17/168

(57) ABSTRACT

A squirrel cage induction machine rotor comprises: a stack of rotor laminations, the stack comprising: a first rotor lamination having a first bar opening with a first size; a second rotor lamination abutting the first rotor lamination and having a second bar opening with a second size greater than the first size; and a third rotor lamination abutting the first rotor lamination and having a third bar opening with a third size, the third size greater than the first size; a first end ring; a second end ring; and a bar extending through each of the second bar opening, the first bar opening and the third bar opening, wherein the bar has a first enlarged connection region defined by the second bar opening, and wherein the bar has a second enlarged connection region defined by the third bar opening.

### TECHNICAL FIELD

This document relates to a squirrel cage induction machine rotor with an enlarged connection region.

### BACKGROUND

Squirrel cage induction machine rotors are manufactured by either die-casting onto a stack of laminations or connecting end-rings onto bars inserted in the rotor slots to form a fully connected cage retained by the rotor stack, and end rings hanging over at the respective ends of the stack. During high-speed rotation of the squirrel cage induction machine rotor, the end rings rely on the connection with the cage bars to maintain structural integrity.

### SUMMARY

In an aspect, a squirrel cage induction machine rotor comprises: a stack of rotor laminations, the stack comprising: a first rotor lamination, the first rotor lamination having a first bar opening with a first size; a second rotor lamination abutting the first rotor lamination at a first axial end of the stack, the second rotor lamination having a second bar opening with a second size, the second size greater than the first size; and a third rotor lamination abutting the first rotor lamination at a second axial end of the stack, the second axial end opposite to the first axial end, the third rotor lamination having a third bar opening with a third size, the third size greater than the first size; a first end ring at the first axial end of the stack; a second end ring at the second axial end of the stack; and a bar connecting the first end ring and the second end ring to each other, the bar extending through each of the second bar opening, the first bar opening and the third bar opening, wherein the bar has a first enlarged connection region defined by the second bar opening, and wherein the bar has a second enlarged connection region defined by the third bar opening.

Implementations can include any of the following features. The squirrel cage induction machine rotor has multiple first rotor laminations including the first rotor lamination, each of the multiple first rotor laminations having a corresponding first bar opening through which the bar extends. The squirrel cage induction machine rotor has multiple second rotor laminations including the second rotor lamination, each of the multiple second rotor laminations having a corresponding second bar opening through which the bar extends. The squirrel cage induction machine rotor has multiple third rotor laminations including the third rotor lamination, each of the multiple third rotor laminations having a corresponding third bar opening through which the bar extends. The squirrel cage induction machine rotor has multiple bars including the bar. Each of the multiple bars has a corresponding first enlarged connection region and a corresponding second enlarged connection region. Fewer than all of the multiple bars has a corresponding first enlarged connection region and a corresponding second enlarged connection region. Alternating ones of the multiple bars has the corresponding first enlarged connection region and the corresponding second enlarged connection region. An edge of the second bar opening abuts, when viewed along an axis of the squirrel cage induction machine rotor, an edge of the first bar opening, such that an edge of the first enlarged connection region abuts an edge of the bar. An edge of the third bar opening abuts, when viewed along an axis of the squirrel cage induction machine rotor, an edge of the first bar opening, such that an edge of the second enlarged connection region abuts an edge of the bar. The second size being greater than the first size comprises that the first extended connection region is wider than the bar when viewed along an axis of the squirrel cage induction machine rotor. The first extended connection region is wider than the bar on both sides of the bar along a direction of rotation. The first extended connection region is wider than the bar on only one side of the bar along a direction of rotation. The third size being greater than the first size comprises that the second extended connection region is wider than the bar when viewed along the axis of the squirrel cage induction machine rotor. The second extended connection region is wider than the bar on a same side of the bar where the first extended connection region is wider than the bar. The second extended connection region is wider than the bar on an opposite side of the bar than where the first extended connection region is wider than the bar. The third size being greater than the first size comprises that the second extended connection region is wider than the bar when viewed along an axis of the squirrel cage induction machine rotor. The second extended connection region is wider than the bar on both sides of the bar along a direction of rotation. The second extended connection region is wider than the bar on only one side of the bar along a direction of rotation. The second size being greater than the first size comprises that the first extended connection region is taller than the bar in a radial direction. The third size being greater than the first size comprises that the second extended connection region is taller than the bar in a radial direction. The bar has an essentially quadrilateral profile when viewed along an axis of the squirrel cage induction machine rotor. The first extended connection region has an essentially quadrilateral profile when viewed along an axis of the squirrel cage induction machine rotor. The second extended connection region has an essentially quadrilateral profile when viewed along an axis of the squirrel cage induction machine rotor. The bar has a circular profile when viewed along an axis of the squirrel cage induction machine rotor. The first extended connection region has a circular profile when viewed along an axis of the squirrel cage induction machine rotor. The second extended connection region has a circular profile when viewed along an axis of the squirrel cage induction machine rotor. The bar has an oval profile when viewed along an axis of the squirrel cage induction machine rotor. The first extended connection region has an oval profile when viewed along an axis of the squirrel cage induction machine rotor. The second extended connection region has an oval profile when viewed along an axis of the squirrel cage induction machine rotor. The bar further comprises a third extended connection region abutting the first extended connection region, the third extended connection region having a different size than the first extended connection region. The third extended connection region is narrower than the first extended connection region, and wider than the bar, when viewed along an axis of the squirrel cage induction machine rotor. The bar further comprises a fourth extended connection region abutting the second extended connection region, the fourth extended connection region having a different size than the second extended connection region. The fourth extended connection region is narrower than the second extended connection region, and wider than the bar, when viewed along an axis of the squirrel cage induction machine rotor. The bar is skewed and not aligned with an axis of the squirrel cage induction machine rotor. The second size being greater than the first size comprises that the first extended connection region is wider than the bar when viewed along an axis of the squirrel cage induction machine rotor. The first extended connection region is wider than the bar on both sides of the bar along a direction of rotation. The first extended connection region is wider than the bar on only one side of the bar along a direction of rotation. The first extended connection region is wider than the bar toward a center of the bar when viewed along an axis of the squirrel cage induction machine rotor. The first extended connection region is wider than the bar away from a center of the bar when viewed along an axis of the squirrel cage induction machine rotor. The second extended connection region has a different profile than the first extended connection region when viewed along an axis of the squirrel cage induction machine rotor.

### BRIEF DESCRIPTION OF DRAWINGS

FIG. 1 schematically shows an example of a squirrel cage induction machine rotor.

FIG. 2 schematically shows an example of the squirrel cage of the squirrel cage induction machine rotor of FIG. 1.

FIG. 3 shows an example of the stack of rotor laminations of the squirrel cage induction machine rotor of FIG. 1.

FIG. 4 shows a section of an example of a squirrel cage induction machine rotor having a stack of rotor laminations, an end ring, an enlarged connection region, and a bar.

FIG. 5 shows a section of an example of a squirrel cage induction machine rotor having a non-skewed bar.

FIG. 6 shows a section of another example of a squirrel cage induction machine rotor having a non-skewed bar.

FIG. 7 shows a section of another example of a squirrel cage induction machine rotor having a non-skewed bar.

FIG. 8 shows a section of another example of a squirrel cage induction machine rotor having a non-skewed bar.

FIG. 9 shows a section of another example of a squirrel cage induction machine rotor having a non-skewed bar.

FIG. 10 shows a section of an example of a squirrel cage induction machine rotor having a skewed bar.

FIG. 11 shows a section of another example of a squirrel cage induction machine rotor having a skewed bar.

FIG. 12 shows a section of another example of a squirrel cage induction machine rotor having a skewed bar.

FIG. 13 shows a section of another example of a squirrel cage induction machine rotor having a skewed bar.

FIG. 14 shows a section of another example of a squirrel cage induction machine rotor having a skewed bar.

FIG. 15 shows a section of a portion of another example of a squirrel cage induction machine rotor having a bar with connection regions abutting each other.

FIG. 16 shows a section of a portion of another example of a squirrel cage induction machine rotor having bars and connection regions with a circular profile.

FIG. 17 shows a section of a portion of another example of a squirrel cage induction machine rotor having bars and connection regions with an oval profile.

FIG. 18 shows a section of a portion of another example of a squirrel cage induction machine rotor having bars with a circular profile and connection regions with a rectangular profile.

FIG. 19 shows a section of a portion of another example of a squirrel cage induction machine rotor having bars with an oval profile and connection regions with a rectangular profile.

FIG. 20 shows a section of a portion of another example of a squirrel cage induction machine rotor having bars, wherein fewer than all of the bars have connection regions.

Like reference symbols in the various drawings indicate like elements.

### DETAILED DESCRIPTION

This document describes examples of systems and techniques that facilitate a squirrel cage induction machine rotor having an enlarged connection region. This can be accomplished by providing the bar slots with different slot dimensions. The present subject matter can improve structural properties and die-castability when die-casting is the process of forming the squirrel cage.

Previous approaches for squirrel cage induction machine rotor manufacturing result in a single-piece squirrel cage being formed that can be characterized as having two regions: cage bars and end rings. The cage bars are embedded in the rotor stack which can be made of laminated electrical steel. The cage bars are retained by the rotor stack while the end rings rely on their connection to the cage bar for structural integrity. During high-speed rotation, the connections between the cage bars and the end rings can be weak spots that are prone to structural failure. As such, some existing squirrel cage induction machine rotors have uniform bar slots along the axial direction. The present subject matter, on the other hand, can have slots with two or more different dimensions, leading to a cage bar shape along the axial direction that improves the structural properties of the squirrel cage induction machine rotor. The present subject matter can be applied to induction machine rotor cages manufactured by die-casting or connecting end-rings to pre-fabricated rotor bars.

The present subject matter can improve the die-casting quality of the cage. In some implementations, an enlarged connection region between a cage bar and an end ring can slow down the die-casted material solidification. For example, this can provide a lower porosity at the non-gate side end ring (the end ring at the opposite side from where the liquid cage material is introduced).

As used herein, a vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle. The vehicle can include a passenger compartment accommodating one or more persons.

As used herein, a squirrel cage induction machine rotor is a rotor that is designed for use in an induction machine (where the rotor current is electromagnetically induced from a magnetic field of a stator winding) and that has respective end rings connected to each other by at least one bar that extends through a stack of rotor laminations. The end rings and the bar can collectively be referred to as a squirrel cage. For example, the squirrel cage can be manufactured by a die-casting process in which molten metal is cast onto and through a stack of rotor laminations, or by connecting end-rings to the pre-fabricated rotor bars.

As used herein, a first opening having a size that is greater than a size of a second opening means that at least one dimension of the first opening is greater than the corresponding dimension(s) of the second opening. For example, the first opening can have a greater width (in at least one location) that is greater than the corresponding width of the second opening. As another example, the first opening can have a greater height (in at least one location) than the corresponding height of the second opening. If the first opening and second opening were to be superimposed on each other, the greater size of the first opening is manifest by extending beyond the boundary of the second opening in at least one location (e.g., by being wider or taller).

As used herein, a bar or an opening has an essentially quadrilateral profile when the bar or opening has either of a slice of annulus shape, a trapezoid shape, a quadrilateral shape, or a rectangular shape. For example, a slice of annulus shape where the arc sides have relatively large radii approximates a quadrilateral shape. As used herein, a shape with rounded corners can be an essentially quadrilateral profile. For example, in order to form an opening having an essentially quadrilateral profile by stamping of a metal sheet, the shape can be provided with rounded (as opposed to angled) corners.

Examples described herein refer to a top, bottom, front, or rear. These and similar expressions identify things or aspects in a relative way based on an express or arbitrary notion of perspective. That is, these terms are illustrative only, used for purposes of explanation, and do not necessarily indicate the only possible position, direction, and so on.

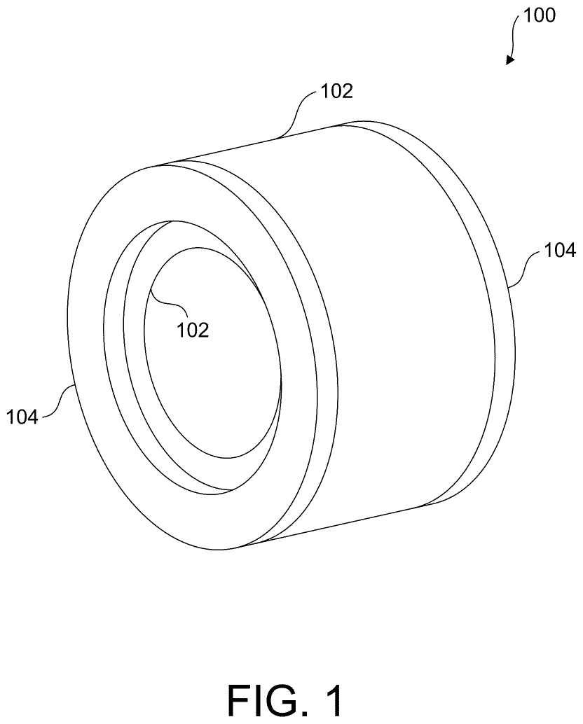

FIG. 1 schematically shows an example of a squirrel cage induction machine rotor 100. The squirrel cage induction machine rotor 100 can be used with one or more other examples described elsewhere herein. The squirrel cage induction machine rotor 100 can include a stack 102 of rotor laminations and a squirrel cage 104. The squirrel cage 104 can include respective end rings (which are visible in the illustration) and bars (not visible) that extend through the stack 102. When installed in an electric motor, the squirrel cage induction machine rotor 100 can be configured to rotate in at least one direction about an axis that extends in a longitudinal direction through the center of the stack 102.

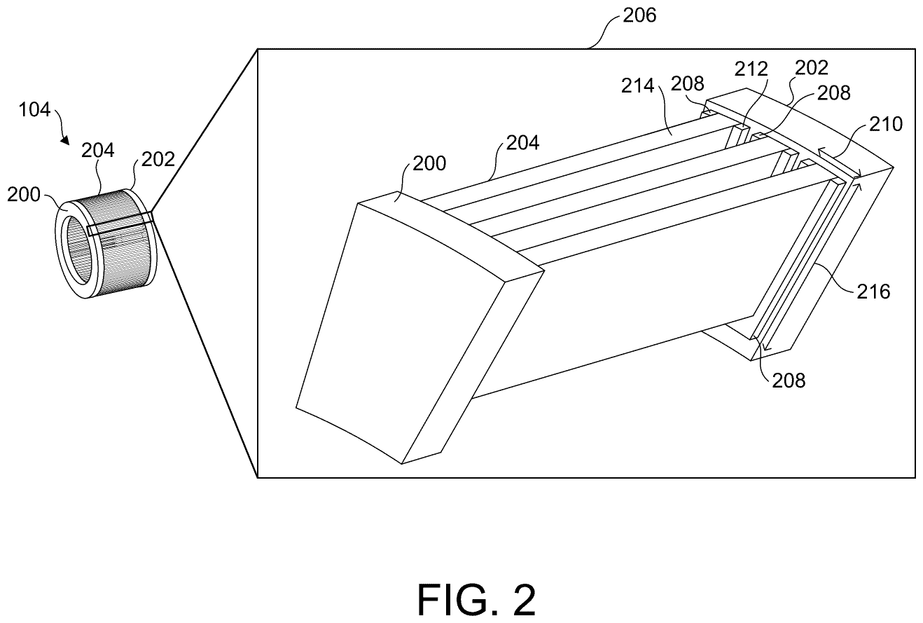

FIG. 2 schematically shows an example of the squirrel cage 104 of the squirrel cage induction machine rotor 100 of FIG. 1. Toward the left in the illustration, the squirrel cage 104 is here shown without the stack 102 of FIG. 1 for illustrative purposes. The squirrel cage 104 can be formed by a die-casting process. In some implementations, molten metal can be flowed through and partially around the stack 102 of FIG. 1 inside a mold, so that end rings 200 and 202, and bars 204 joining the end rings 200 and 202, are cast. That is, in the die-casting process the end rings 200 and 202 and the bars 204 are molded based on the mold and the stack 102 of FIG. 1. The metal being cast as the squirrel cage 104 can include aluminum (e.g., an alloy thereof) and/or copper (e.g., an alloy thereof). The squirrel cage 104 can also be formed by connecting the end rings 200 and 202 to bars 204, by methods including but not limited to welding, interference fit, or brazing. Each of the multiple bars has one end connected to the end ring 200 and an opposite end connected to the end ring 202. The end rings 200 and 202 can have the same profile as each other or can have profiles that differ from each other in one or more regards.

An enlargement 206 shows a section of the squirrel cage 104 that includes portions of the end rings 200 and 202 and three of the bars 204. The section shown in the enlargement 206 can be representative of the geometry of the rest of the squirrel cage 104. Each of the bars 204 has an enlarged connection region 208 where the bar 204 connects to the end ring 202. The enlarged connection region 208 is embedded in the stack 102 of FIG. 1 in the squirrel cage induction machine rotor 100. Here, each of the bars 204 is shown with a corresponding instance of the enlarged connection region 208. While not visible here, one or more of the bars 204 may have the enlarged connection region 208 at each of its connections to the end rings 200 and 202. In some implementations, fewer than all of the bars 204 can have the enlarged connection region 208 to the end ring 200 and/or 202.

Here, the enlarged connection region 208 has an essentially quadrilateral profile when viewed along the axis of the squirrel cage induction machine rotor 100 of FIG. 1. For example, in that view the enlarged connection region 208 is shaped as a slice of an annulus, with two edges angled toward each other being connected to each other by arcs. The edges may or may not be aligned with radii of the rotor. Other shapes can be used for the enlarged connection region 208, for example as shown elsewhere herein.

The enlarged connection region 208 has a size greater than the size of the bar 204 in one or more regards. In some implementations, a width 210 of the enlarged connection region 208 is greater than a corresponding width of the bar 204. The enlarged connection region 208 can be wider, in the direction of rotation, than the bar 204 on either or both sides thereof. For example, here the enlarged connection region 208 extends on both sides of the bar 204.

When viewed along the axis of the squirrel cage induction machine rotor 100 of FIG. 1, the enlarged connection region 208 can have an edge 212 that abuts (e.g., is aligned with) an edge 214 of the bar 204. This can provide one or more advantages. The distance between the edge 214 and the top of the end ring 202 can correspond to a bridge of the squirrel cage induction machine rotor 100 of FIG. 1, the bridge defined by the stack 102. The bridge can have at least a minimum dimension to eliminate punching through. Yet the closer the bars 204 are to the outside of the squirrel cage induction machine rotor 100, the better the performance of the motor. As such, it can be advantageous to have the edge 212 abut the edge 214.

In some implementations, a height 216 of the enlarged connection region 208 is greater than a corresponding height of the bar 204. That is, the enlarged connection region 208 is here taller than the bar 204 in a radial direction of the squirrel cage induction machine rotor 100 of FIG. 1. For example, the enlarged connection region 208 can extend further toward the axis of the rotor than does the bar 204.

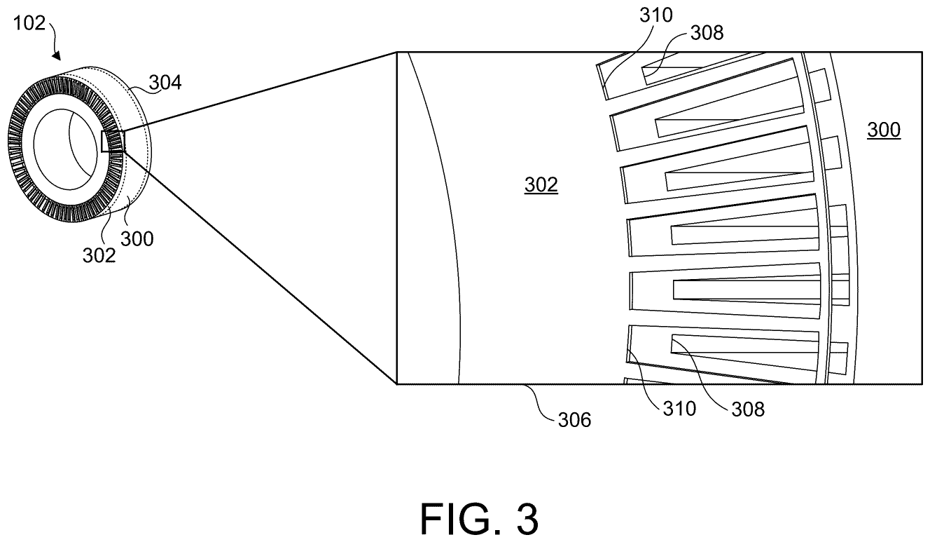

FIG. 3 shows an example of the stack 102 of rotor laminations of the squirrel cage induction machine rotor 100 of FIG. 1. The stack 102 can be formed by stacking and joining the laminations to each other. For example, stamped steel laminations having at least two different configurations can be used. The stack 102 includes a body 300 and end laminations 302 and 304. Each of the body 300 and the end laminations 302 and 304 can include one or more laminations. That is, the stack 102 has the end lamination(s) 302 abutting the body 300 at a first axial end of the stack 102, and the end lamination(s) 304 abutting the body 300 at a second axial end of the stack 102 opposite the first end.

An enlargement 306 shows a portion of the stack 102 with the end lamination(s) 302 having been separated slightly from the body 300 for illustrative purposes. Here, a bar opening 308 is formed in the body 300 (e.g., in each lamination thereof), and correspondingly a bar opening 310 is formed in (each of) the end lamination(s) 302. Here, each of the bar openings 308 and 310 has an essentially quadrilateral profile (e.g., a sliced annulus shape). Respective instances of the bar openings 308 and 310 are aligned with each other in the stack 102 so that a bar can be formed through the bar openings 308 and 310 in the die-casting process. The end lamination 304 can also have a corresponding bar opening, identical to or different from the bar opening 310 of the end lamination 302, aligned with the opening 308.

The size of the opening 310 is greater than the size of the opening 308 in one or more regards. In some implementations, the opening 310 is wider than the opening 308 when viewed along the axis of the stack 102. In some implementations, the opening 310 is taller than the opening 308 in a radial direction of the stack 102. Other approaches can be used.

The above examples illustrate that a squirrel cage induction machine rotor (e.g., the squirrel cage induction machine rotor 100 of FIG. 1) can include: a stack of rotor laminations (e.g., the stack 102), the stack comprising: a first rotor lamination (e.g., the body 300), the first rotor lamination having a first bar opening (e.g., the opening 308) with a first size; a second rotor lamination (e.g., the lamination 302) abutting the first rotor lamination at a first axial end of the stack, the second rotor lamination having a second bar opening (e.g., the bar opening 310) with a second size, the second size greater than the first size; and a third rotor lamination (e.g., the end lamination 304) abutting the first rotor lamination at a second axial end of the stack, the second axial end opposite to the first axial end, the third rotor lamination having a third bar opening with a third size, the third size greater than the first size; a first end ring (e.g., the end ring 200) at the first axial end of the stack; a second end ring (e.g., the end ring 202) at the second axial end of the stack; and a bar (e.g., the bar 204) connecting the first end ring and the second end ring to each other, the bar extending through each of the second bar opening, the first bar opening and the third bar opening, wherein the bar has a first enlarged connection region (e.g., the enlarged connection region 208) defined by the second bar opening, and wherein the bar has a second enlarged connection region defined by the third bar opening.

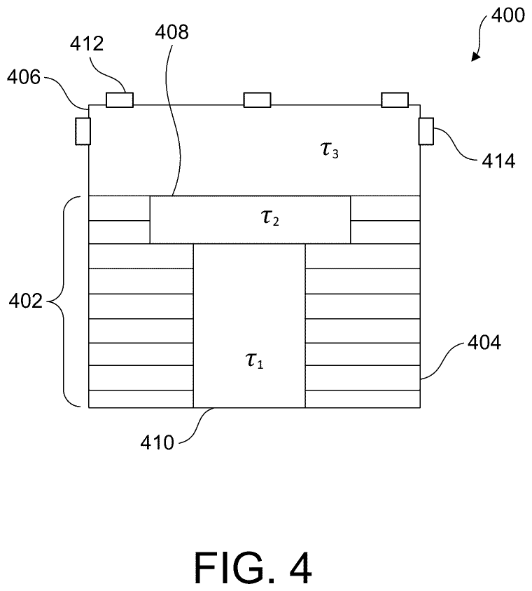

FIG. 4 shows a section 400 of an example of a squirrel cage induction machine rotor having a stack 402 of rotor laminations 404, an end ring 406, an enlarged connection region 408, and a bar 410. The section 400 is shown in a radial direction of the rotor and shows only a portion of each of the components.

Providing the enlarged connection region 408 can give one or more advantages. Going from the bar 410 to the end ring 406 during operation of the motor, shear stress can exist at the interface due to centrifugal force. Here, the bar 410 has shear stress τ₁, the enlarged connection region 408 has shear stress τ₂, and the end ring 406 has shear stress τ₃, with τ₁<τ₂<τ₃. That is, the increase in shear stress between the bar 410 and the end ring 406 can be divided into two steps in this example. Also, the enlarged connection region 408, unlike the end ring 406, is embedded in and held by the stack 402 during rotation. As such, the enlarged connection region 408 can hold the end ring 406 better during high-speed rotation.

The enlarged connection region 408 can also slow down solidification of the die-casted material. In the die-casting process, molten metal can be injected into the mold through a gate of the mold at one end of the stack 402, at which location the nearest end ring is to be formed. The mold used for the squirrel cage can have at least one gate for injecting molten metal. In some implementations, the mold can have one or more axial gates 412, wherein the enlarged connection region 408 and the bar 410 are formed on an opposite side of the end ring 406 from the axial gate(s) 412. In some implementations, the mold can have one or more lateral gates 414, the lateral gate(s) 414 being situated where a surface of the end ring 406 is to be formed that is perpendicular to the longitudinal axis of the bar 410. Other approaches can be used.

The molten material flows through one or more bar openings of the stack 402 so as to form one or more instances of the bar 410. At the non-gate end of the mold, the molten material (by now having a somewhat lower temperature) forms the end ring 406. The end ring 406 has relatively more mass than the bar 410, so the end ring 406 cools slower than the bar 410. The enlarged connection region 408 can provide a more gradual transition between the different cooling rates of the end ring 406 and the bar 410, thereby improving the construction of the rotor.

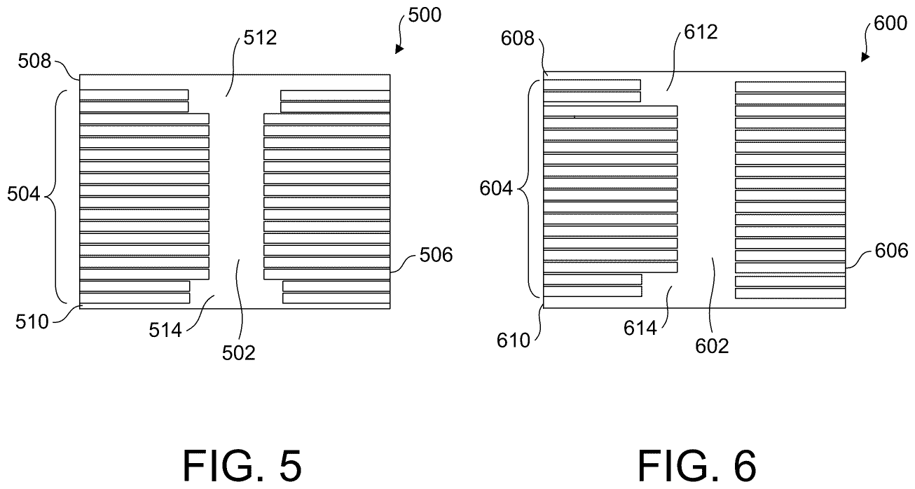

FIG. 5 shows a section of an example of a squirrel cage induction machine rotor 500 having a non-skewed bar 502. The squirrel cage induction machine rotor 500 can be used with one or more other examples described elsewhere herein. The squirrel cage induction machine rotor 500 has a stack 504 of rotor laminations 506; end rings 508 and 510; and enlarged connection regions 512 and 514. The non-skewed bar 502 forms essentially a right angle with each of the end rings 508 and 510. Here, each of the enlarged connection regions 512 and 514 is wider, in the rotation direction when viewed along the axis of the squirrel cage induction machine rotor 500, than the non-skewed bar 502 on both sides of the non-skewed bar 502. Each of the enlarged connection regions 512 and 514 can have an essentially quadrilateral profile when viewed along an axis of the squirrel cage induction machine rotor. In other implementations, one or both of the enlarged connection regions 512 and 514 can have a different profile.

FIG. 6 shows a section of another example of a squirrel cage induction machine rotor 600 having a non-skewed bar 602. The squirrel cage induction machine rotor 600 can be used with one or more other examples described elsewhere herein. The squirrel cage induction machine rotor 600 has a stack 604 of rotor laminations 606; end rings 608 and 610; and enlarged connection regions 612 and 614. The non-skewed bar 602 forms essentially a right angle with each of the end rings 608 and 610. Here, each of the enlarged connection regions 612 and 614 is wider, in the rotation direction when viewed along the axis of the squirrel cage induction machine rotor 600, than the non-skewed bar 602 on only one side of the non-skewed bar 602. That is, each of the enlarged connection regions 612 and 614 is wider than the non-skewed bar 602 away from the center of the non-skewed bar 602. Each of the enlarged connection regions 612 and 614 can have an essentially quadrilateral profile when viewed along an axis of the squirrel cage induction machine rotor. In other implementations, one or both of the enlarged connection regions 612 and 614 can have a different profile.

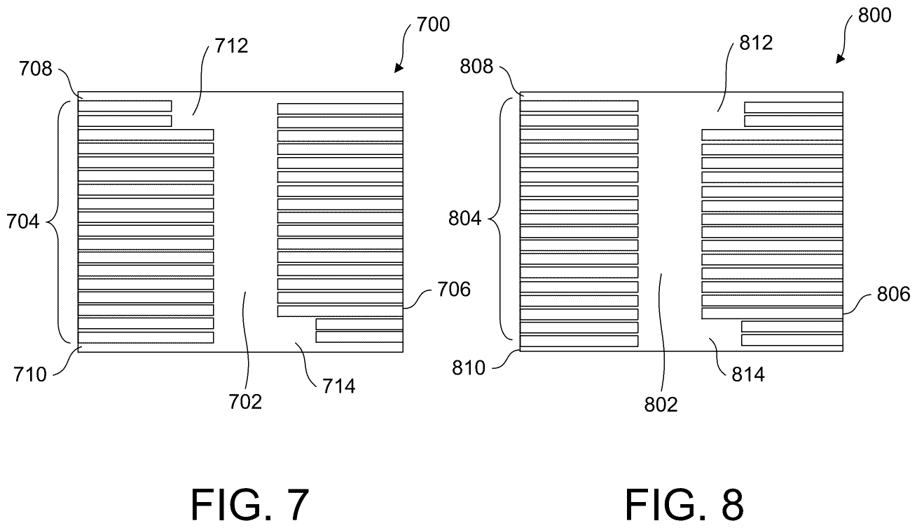

FIG. 7 shows a section of another example of a squirrel cage induction machine rotor 700 having a non-skewed bar 702. The squirrel cage induction machine rotor 700 can be used with one or more other examples described elsewhere herein. The squirrel cage induction machine rotor 700 has a stack 704 of rotor laminations 706; end rings 708 and 710; and enlarged connection regions 712 and 714. The non-skewed bar 702 forms essentially a right angle with each of the end rings 708 and 710. The squirrel cage induction machine rotor 700 is an asymmetric design. The enlarged connection region 712 is wider, in the rotation direction when viewed along the axis of the squirrel cage induction machine rotor 700, than the non-skewed bar 702 on only one side of the non-skewed bar 702. The enlarged connection region 714 is wider than the non-skewed bar 702 on an opposite side of the non-skewed bar 702 than where the enlarged connection region 712 is wider than the non-skewed bar 702. Each of the enlarged connection regions 712 and 714 can have an essentially quadrilateral profile when viewed along an axis of the squirrel cage induction machine rotor. In other implementations, one or both of the enlarged connection regions 712 and 714 can have a different profile.

FIG. 8 shows a section of another example of a squirrel cage induction machine rotor 800 having a non-skewed bar 802. The squirrel cage induction machine rotor 800 can be used with one or more other examples described elsewhere herein. The squirrel cage induction machine rotor 800 has a stack 804 of rotor laminations 806; end rings 808 and 810; and enlarged connection regions 812 and 814. The non-skewed bar 802 forms essentially a right angle with each of the end rings 808 and 810. Here, each of the enlarged connection regions 812 and 814 is wider, in the rotation direction when viewed along the axis of the squirrel cage induction machine rotor 800, than the non-skewed bar 802 on only one side of the non-skewed bar 802. Each of the enlarged connection regions 812 and 814 can have an essentially quadrilateral profile when viewed along an axis of the squirrel cage induction machine rotor. In other implementations, one or both of the enlarged connection regions 812 and 814 can have a different profile.

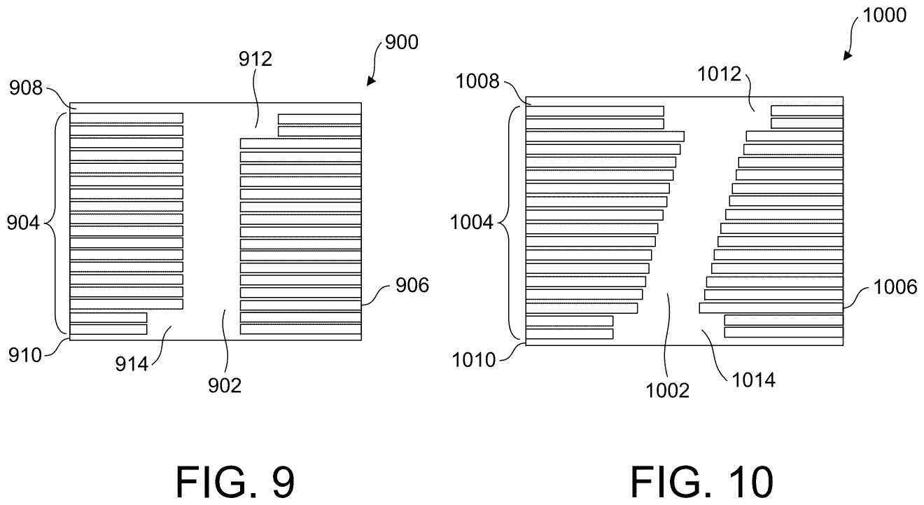

FIG. 9 shows a section of another example of a squirrel cage induction machine rotor 900 having a non-skewed bar 902. The squirrel cage induction machine rotor 900 can be used with one or more other examples described elsewhere herein. The squirrel cage induction machine rotor 900 has a stack 904 of rotor laminations 906; end rings 908 and 910; and enlarged connection regions 912 and 914. The non-skewed bar 902 forms essentially a right angle with each of the end rings 908 and 910. The squirrel cage induction machine rotor 900 is an asymmetric design. The enlarged connection region 912 is wider, in the rotation direction when viewed along the axis of the squirrel cage induction machine rotor 900, than the non-skewed bar 902 on only one side of the non-skewed bar 902. The enlarged connection region 914 is wider than the non-skewed bar 902 on an opposite side of the non-skewed bar 902 than where the enlarged connection region 912 is wider than the non-skewed bar 902. Each of the enlarged connection regions 912 and 914 can have an essentially quadrilateral profile when viewed along an axis of the squirrel cage induction machine rotor. In other implementations, one or both of the enlarged connection regions 912 and 914 can have a different profile.

FIG. 10 shows a section of an example of a squirrel cage induction machine rotor 1000 having a skewed bar 1002. The squirrel cage induction machine rotor 1000 can be used with one or more other examples described elsewhere herein. The squirrel cage induction machine rotor 1000 has a stack 1004 of rotor laminations 1006; end rings 1008 and 1010; and enlarged connection regions 1012 and 1014. The skewed bar 1002 is skewed relative to each of the end rings 1008 and 1010 and is not aligned with the axis of the squirrel cage induction machine rotor 1000. For example, skewing can reduce noise, vibration and harshness (NVH) of the vehicle in which the motor is installed. Here, each of the enlarged connection regions 1012 and 1014 is wider, in the rotation direction when viewed along the axis of the squirrel cage induction machine rotor 1000, than the skewed bar 1002 on both sides of the skewed bar 1002. Each of the enlarged connection regions 1012 and 1014 can have an essentially quadrilateral profile when viewed along an axis of the squirrel cage induction machine rotor. In other implementations, one or both of the enlarged connection regions 1012 and 1014 can have a different profile.

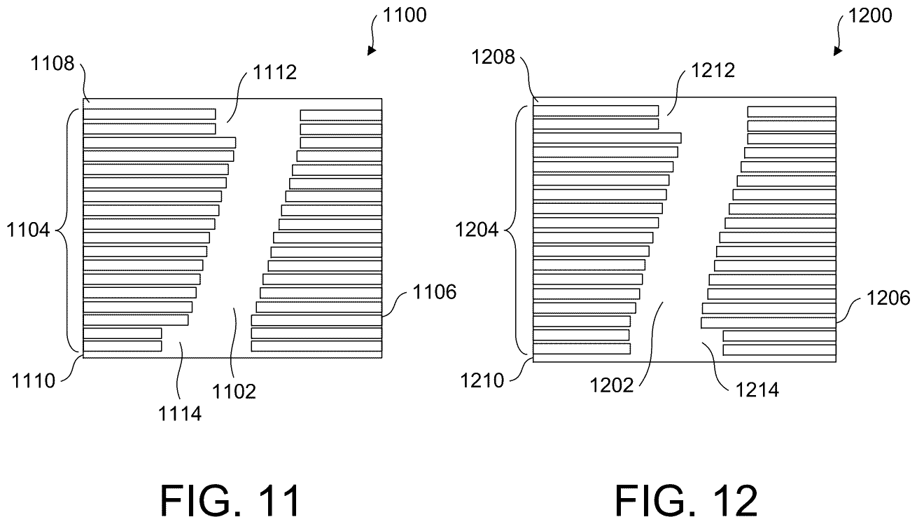

FIG. 11 shows a section of another example of a squirrel cage induction machine rotor 1100 having a skewed bar 1102. The squirrel cage induction machine rotor 1100 can be used with one or more other examples described elsewhere herein. The squirrel cage induction machine rotor 1100 has a stack 1104 of rotor laminations 1106; end rings 1108 and 1110; and enlarged connection regions 1112 and 1114. The skewed bar 1102 is skewed relative to each of the end rings 1108 and 1110. Here, each of the enlarged connection regions 1112 and 1114 is wider, in the rotation direction when viewed along the axis of the squirrel cage induction machine rotor 1100, than the skewed bar 1102 on only one side of the skewed bar 1102. Each of the enlarged connection regions 1112 and 1114 can have an essentially quadrilateral profile when viewed along an axis of the squirrel cage induction machine rotor. In other implementations, one or both of the enlarged connection regions 1112 and 1114 can have a different profile.

FIG. 12 shows a section of another example of a squirrel cage induction machine rotor 1200 having a skewed bar 1202. The squirrel cage induction machine rotor 1200 can be used with one or more other examples described elsewhere herein. The squirrel cage induction machine rotor 1200 has a stack 1204 of rotor laminations 1206; end rings 1208 and 1210; and enlarged connection regions 1212 and 1214. The skewed bar 1202 is skewed relative to each of the end rings 1208 and 1210. The enlarged connection region 1212 is wider, in the rotation direction when viewed along the axis of the squirrel cage induction machine rotor 1200, than the skewed bar 1202 on only one side of the skewed bar 1202. The enlarged connection region 1214 is wider than the skewed bar 1202 on an opposite side of the skewed bar 1202 than where the enlarged connection region 1212 is wider than the skewed bar 1202. Each of the enlarged connection regions 1212 and 1214 can have an essentially quadrilateral profile when viewed along an axis of the squirrel cage induction machine rotor. In other implementations, one or both of the enlarged connection regions 1212 and 1214 can have a different profile.

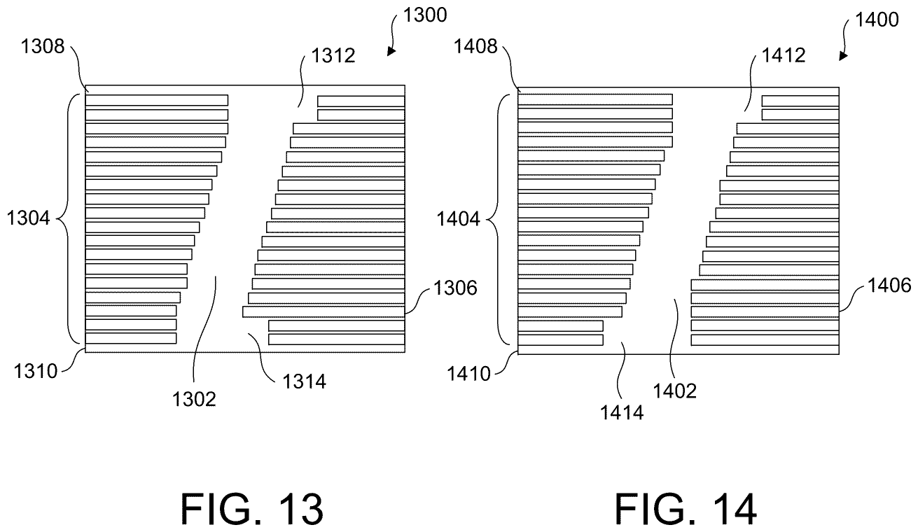

FIG. 13 shows a section of another example of a squirrel cage induction machine rotor 1300 having a skewed bar 1302. The squirrel cage induction machine rotor 1300 can be used with one or more other examples described elsewhere herein. The squirrel cage induction machine rotor 1300 has a stack 1304 of rotor laminations 1306; end rings 1308 and 1310; and enlarged connection regions 1312 and 1314. The skewed bar 1302 is skewed relative to each of the end rings 1308 and 1310. Here, each of the enlarged connection regions 1312 and 1314 is wider, in the rotation direction when viewed along the axis of the squirrel cage induction machine rotor 1300, than the skewed bar 1302 on only one side of the skewed bar 1302. Each of the enlarged connection regions 1312 and 1314 can have an essentially quadrilateral profile when viewed along an axis of the squirrel cage induction machine rotor. In other implementations, one or both of the enlarged connection regions 1312 and 1314 can have a different profile.

FIG. 14 shows a section of another example of a squirrel cage induction machine rotor 1400 having a skewed bar 1402. The squirrel cage induction machine rotor 1400 can be used with one or more other examples described elsewhere herein. The squirrel cage induction machine rotor 1400 has a stack 1404 of rotor laminations 1406; end rings 1408 and 1410; and enlarged connection regions 1412 and 1414. The skewed bar 1402 is skewed relative to each of the end rings 1408 and 1410. The enlarged connection region 1412 is wider, in the rotation direction when viewed along the axis of the squirrel cage induction machine rotor 1400, than the skewed bar 1402 on only one side of the skewed bar 1402. The enlarged connection region 1414 is wider than the skewed bar 1402 on an opposite side of the skewed bar 1402 than where the enlarged connection region 1412 is wider than the skewed bar 1402. Each of the enlarged connection regions 1412 and 1414 can have an essentially quadrilateral profile when viewed along an axis of the squirrel cage induction machine rotor. In other implementations, one or both of the enlarged connection regions 1412 and 1414 can have a different profile.

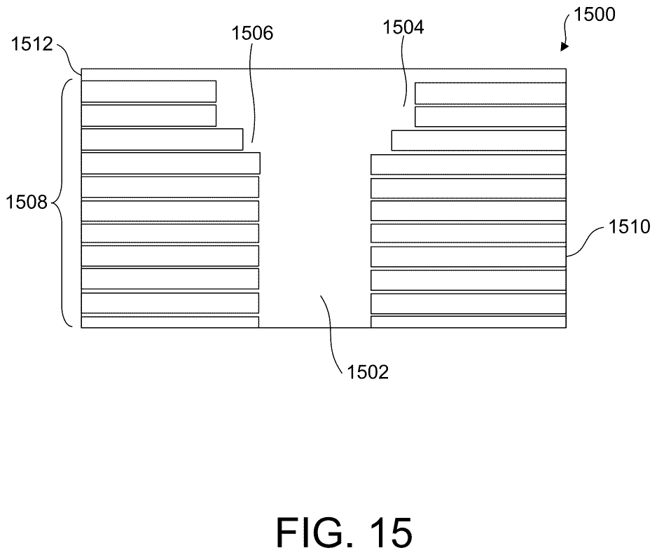

FIG. 15 shows a section of a portion of another example of a squirrel cage induction machine rotor 1500 having a bar 1502 with connection regions 1504 and 1506 abutting each other. The squirrel cage induction machine rotor 1500 can be used with one or more other examples described elsewhere herein. The squirrel cage induction machine rotor 1500 has a stack of rotor laminations of which a stack 1508 of rotor laminations 1510 is shown; end rings of which an end ring 1512 is shown; and the enlarged connection regions 1504 and 1506 between the bar 1502 and the end ring 1512. The bar 1502 is a non-skewed bar and forms essentially a right angle with the end ring 1512. Here, each of the enlarged connection regions 1504 and 1506 is wider, in the rotation direction when viewed along the axis of the squirrel cage induction machine rotor 1500, than the bar 1502 on both sides of the bar 1502. The enlarged connection region 1506 has a different size than the enlarged connection region 1504. For example, the enlarged connection region 1506 can be narrower than the enlarged connection region 1504, and wider than the bar 1502, when viewed along the axis of the squirrel cage induction machine rotor 1500. In some implementations, the squirrel cage induction machine rotor 1500 can have one or more enlarged connection regions at the opposite end of the bar 1502. Each of the enlarged connection regions 1504 and 1506 can have an essentially quadrilateral profile when viewed along an axis of the squirrel cage induction machine rotor. In other implementations, one or both of the enlarged connection regions 1504 and 1506 can have a different profile.

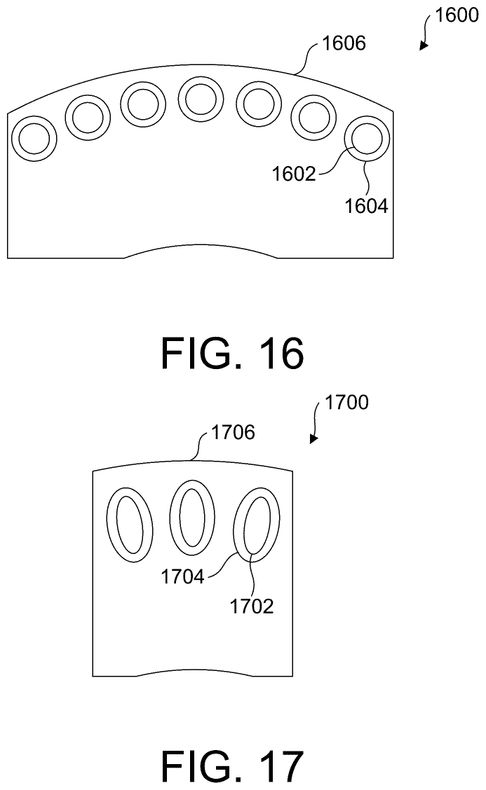

FIG. 16 shows a section of a portion of another example of a squirrel cage induction machine rotor 1600 having bars 1602 and connection regions 1604 with a circular profile. The squirrel cage induction machine rotor 1600 can be used with one or more other examples described elsewhere herein. The section shown can be representative of the geometry of the rest of the squirrel cage induction machine rotor 1600. The view is shown along the axis of the squirrel cage induction machine rotor 1600 toward an end ring 1606. In this and the following examples, the stack of rotor laminations is omitted from view for clarity. Each of the bars 1602 has an instance of the enlarged connection region 1604 where the bar 1602 connects to the end ring 1606. While not visible here, one or more of the bars 1602 may have the enlarged connection region 1604 also at its opposite end where the bar 1602 connects to the other end ring. In some implementations, fewer than all of the bars 1602 can have the enlarged connection region 1604 to the end ring 1606.

FIG. 17 shows a section of a portion of another example of a squirrel cage induction machine rotor 1700 having bars 1702 and connection regions 1704 with an oval profile. The squirrel cage induction machine rotor 1700 can be used with one or more other examples described elsewhere herein. The section shown can be representative of the geometry of the rest of the squirrel cage induction machine rotor 1700. The view is shown along the axis of the squirrel cage induction machine rotor 1700 toward an end ring 1706. Each of the bars 1702 has an instance of the enlarged connection region 1704 where the bar 1702 connects to the end ring 1706. While not visible here, one or more of the bars 1702 may have the enlarged connection region 1704 also at its opposite end where the bar 1702 connects to the other end ring. In some implementations, fewer than all of the bars 1702 can have the enlarged connection region 1704 to the end ring 1706.

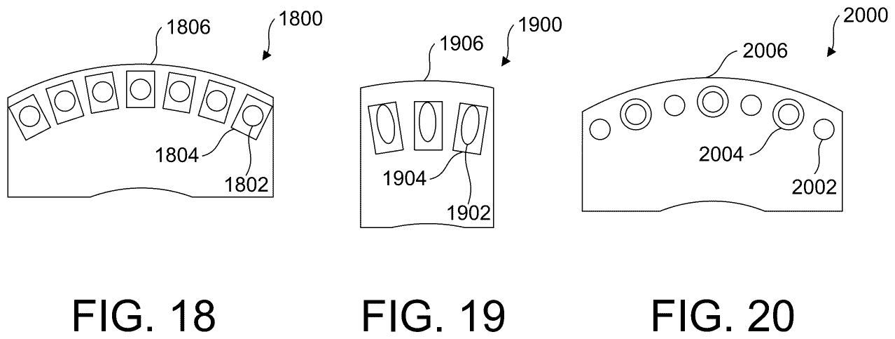

FIG. 18 shows a section of a portion of another example of a squirrel cage induction machine rotor 1800 having bars 1802 with a circular profile and connection regions 1804 with a rectangular profile. The squirrel cage induction machine rotor 1800 can be used with one or more other examples described elsewhere herein. The section shown can be representative of the geometry of the rest of the squirrel cage induction machine rotor 1800. The view is shown along the axis of the squirrel cage induction machine rotor 1800 toward an end ring 1806. Each of the bars 1802 has an instance of the enlarged connection region 1804 where the bar 1802 connects to the end ring 1806. While not visible here, one or more of the bars 1802 may have the enlarged connection region 1804 also at its opposite end where the bar 1802 connects to the other end ring. In some implementations, fewer than all of the bars 1802 can have the enlarged connection region 1804 to the end ring 1806.

FIG. 19 shows a section of a portion of another example of a squirrel cage induction machine rotor 1900 having bars 1902 with an oval profile and connection regions 1904 with a rectangular profile. The squirrel cage induction machine rotor 1900 can be used with one or more other examples described elsewhere herein. The section shown can be representative of the geometry of the rest of the squirrel cage induction machine rotor 1900. The view is shown along the axis of the squirrel cage induction machine rotor 1900 toward an end ring 1906. Each of the bars 1902 has an instance of the enlarged connection region 1904 where the bar 1902 connects to the end ring 1906. An edge of the enlarged connection region 1904 can abut an edge of the bar 1902. While not visible here, one or more of the bars 1902 may have the enlarged connection region 1904 also at its opposite end where the bar 1902 connects to the other end ring. In some implementations, fewer than all of the bars 1902 can have the enlarged connection region 1904 to the end ring 1906.

FIG. 20 shows a section of a portion of another example of a squirrel cage induction machine rotor 2000 having bars 2002, wherein fewer than all of the bars 2002 have connection regions. The squirrel cage induction machine rotor 2000 can be used with one or more other examples described elsewhere herein. The section shown can be representative of the geometry of the rest of the squirrel cage induction machine rotor 2000. The view is shown along the axis of the squirrel cage induction machine rotor 2000 toward an end ring 2006. Some of the bars 2002 have an instance of an enlarged connection region 2004 where that bar 2002 connects to the end ring 2006. Others of the bars 2002 do not have the enlarged connection region 2004 where that bar 2002 connects to the end ring 2006. For example, alternating ones of the bars 2002 can have the enlarged connection region 2004 to the end ring 2006. While not visible here, one or more of the bars 2002 may have the enlarged connection region 2004 (also) at its opposite end where the bar 2002 connects to the other end ring.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A squirrel cage induction machine rotor comprising:
a stack of rotor laminations, the stack comprising:
a first rotor lamination, the first rotor lamination having a first bar opening with a first size;
a second rotor lamination abutting the first rotor lamination at a first axial end of the stack, the second rotor lamination having a second bar opening with a second size, the second size greater than the first size; and
a third rotor lamination abutting the first rotor lamination at a second axial end of the stack, the second axial end opposite to the first axial end, the third rotor lamination having a third bar opening with a third size, the third size greater than the first size;
a first end ring at the first axial end of the stack;
a second end ring at the second axial end of the stack; and
a bar connecting the first end ring and the second end ring to each other, the bar extending through each of the second bar opening, the first bar opening and the third bar opening, wherein the bar has a first enlarged connection region defined by the second bar opening, and wherein the bar has a second enlarged connection region defined by the third bar opening.

2. (canceled)

3. (canceled)

4. (canceled)

5. (canceled)

6. (canceled)

7. (canceled)

8. (canceled)

9. The squirrel cage induction machine rotor of claim 1, wherein an edge of the second bar opening abuts, when viewed along an axis of the squirrel cage induction machine rotor, an edge of the first bar opening, such that an edge of the first enlarged connection region abuts an edge of the bar.

10. (canceled)

11. The squirrel cage induction machine rotor of claim 1, wherein the second size being greater than the first size comprises that the first extended connection region is wider than the bar when viewed along an axis of the squirrel cage induction machine rotor.

12. (canceled)

13. The squirrel cage induction machine rotor of claim 11, wherein the first extended connection region is wider than the bar on only one side of the bar along a direction of rotation.

14. The squirrel cage induction machine rotor of claim 13, wherein the third size being greater than the first size comprises that the second extended connection region is wider than the bar when viewed along the axis of the squirrel cage induction machine rotor.

15. The squirrel cage induction machine rotor of claim 14, wherein the second extended connection region is wider than the bar on a same side of the bar where the first extended connection region is wider than the bar.

16. The squirrel cage induction machine rotor of claim 14, wherein the second extended connection region is wider than the bar on an opposite side of the bar than where the first extended connection region is wider than the bar.

17. (canceled)

18. (canceled)

19. (canceled)

20. The squirrel cage induction machine rotor of claim 1, wherein the second size being greater than the first size comprises that the first extended connection region is taller than the bar in a radial direction.

21. (canceled)

22. (canceled)

23. The squirrel cage induction machine rotor of claim 1, wherein the first extended connection region has an essentially quadrilateral profile when viewed along an axis of the squirrel cage induction machine rotor.

24. (canceled)

25. The squirrel cage induction machine rotor of claim 1, wherein the bar has a circular profile when viewed along an axis of the squirrel cage induction machine rotor.

26. The squirrel cage induction machine rotor of claim 1, wherein the first extended connection region has a circular profile when viewed along an axis of the squirrel cage induction machine rotor.

27. (canceled)

28. The squirrel cage induction machine rotor of claim 1, wherein the bar has an oval profile when viewed along an axis of the squirrel cage induction machine rotor.

29. The squirrel cage induction machine rotor of claim 1, wherein the first extended connection region has an oval profile when viewed along an axis of the squirrel cage induction machine rotor.

30. The squirrel cage induction machine rotor of claim 1, wherein the second extended connection region has an oval profile when viewed along an axis of the squirrel cage induction machine rotor.

31. The squirrel cage induction machine rotor of claim 1, wherein the bar further comprises a third extended connection region abutting the first extended connection region, the third extended connection region having a different size than the first extended connection region.

32. The squirrel cage induction machine rotor of claim 31, wherein the third extended connection region is narrower than the first extended connection region, and wider than the bar, when viewed along an axis of the squirrel cage induction machine rotor.

33. (canceled)

34. (canceled)

35. The squirrel cage induction machine rotor of claim 1, wherein the bar is skewed and not aligned with an axis of the squirrel cage induction machine rotor.

36. The squirrel cage induction machine rotor of claim 35, wherein the second size being greater than the first size comprises that the first extended connection region is wider than the bar when viewed along an axis of the squirrel cage induction machine rotor.

37. The squirrel cage induction machine rotor of claim 36, wherein the first extended connection region is wider than the bar on both sides of the bar along a direction of rotation.

38. The squirrel cage induction machine rotor of claim 36, wherein the first extended connection region is wider than the bar on only one side of the bar along a direction of rotation.

39. (canceled)

40. (canceled)

41. (canceled)
